(19) United States
(12) Patent Application Publication
(10) Pub. No.: US 2020/0016038 A1
(43) Pub. Date: Jan. 16, 2020

(54) EXTRACTION APPARATUS

(71) Applicant: CambTEK Limited, Cambridge (GB)

(72) Inventors: Hugh MALKIN, Cambridge (GB); Nicholas James HASTINGS, Cambridge (GB); Finbarr Charles Ronald WILLIAMSON, Cambridge (GB)

(21) Appl. No.: 16/445,070

(22) Filed: Jun. 18, 2019

Related U.S. Application Data
(63) Continuation of application No. PCT/GB2017/053799, filed on Dec. 19, 2017.

(30) Foreign Application Priority Data
Dec. 19, 2016 (GB) 1621563.4
May 22, 2017 (GB) 1708184.5

(51) Int. Cl. A61J 7/00; A61J 1/10; A61J 1/03; B02C 1/04; B02C 23/36

(52) U.S. Cl. CPC A61J 7/0007; A61J 1/10; B02C 23/36; B02C 1/04; A61J 1/03

(57) ABSTRACT

Apparatuses for pulverizing a solid dosage form and for distributing, dissolving and/or suspending a solid dosage form in an extraction fluid, as well as related methods and processes for producing extracted solid dosage forms using such methods are disclosed.

### CROSS-REFERENCE TO RELATED APPLICATIONS

This application is a continuation of International Application No. PCT/GB2017/053799, filed Dec. 19, 2017, which claims priority to UK Application No. GB1621563.4, filed Dec. 19, 2016, and GB1708184.5, filed May 22, 2017 under 35 U.S.C. § 119(a). Each of the above-referenced patent applications is incorporated by reference in its entirety.

### BACKGROUND OF THE INVENTION

### Field of the Invention

The invention relates to apparatus for pulverizing a solid dosage form and for distributing, dissolving and/or suspending a solid dosage form in an extraction fluid, as well as to related methods and processes for producing extracted solid dosage forms using such methods.

### Description of the Related Technology

Dissolution or extraction of drug dosage forms is routinely used in drug quality control (e.g. to assess batch-to-batch consistency of solid oral dosage forms such as pills, capsules and tablets) as well as in drug development (e.g. to predict in vivo drug release dynamics).

WO 2010/020752 describes an apparatus for the rapid extraction of drug dosage forms, including tablets, gels and powders. The apparatus includes a flow cell for holding the test substance and having an inlet and an outlet; an extraction chamber located between said inlet and outlet comprising a convergent nozzle; and a recirculating pump for driving extraction fluid: (i) into the flow cell via the inlet; (ii) through the extraction chamber; and (iii) back to the flow cell via the outlet, whereby a pressure differential is established across the extraction chamber such that the velocity of the extraction fluid is greater at the outlet than at the inlet. The apparatus is used to progressively erode solid drug dosage forms by creating vigorous turbulence in which the disintegrating solids act “like sand blasting” to increase the rate of product extraction whilst avoiding the need for an “intrusive abrading device”, such as a “homogenizer”.

WO 2014/033429 also describes apparatus for the rapid extraction of drug dosage forms, including tablets, gels and powders. In a similar way to that described in WO 2010/020752, the apparatus is used to progressively erode solid drug dosage forms by creating vigorous turbulence, the flow cell comprising an extraction chamber located between said inlet and outlet comprising a convergent nozzle whereby a pressure differential is established across the extraction chamber such that the velocity of the extraction fluid is greater at the outlet than at the inlet.

In both WO 2010/020752 and WO 2014/033429 ultrasound and/or grooves within the flow cell are employed to accelerate extraction.

However, the approach described in WO 2010/020752 and WO 2014/033429 cannot quickly or reliably extract certain solid dosage forms, including for example certain slow-release, sustained release or tamper-proof dosage forms. In particular, it has now also been discovered that progressive erosion, vigorous turbulence, high pressure and flow velocities, ultrasound and grooved extraction chambers as described in WO 2010/020752 and WO 2014/033429 do not permit the reliable extraction of certain slow-release, sustained release or tamper-proof dosage forms.

WO 2016/005766 describes apparatus for distributing a solid, gel, powder, granular, liquid or viscous test substance in an extraction fluid which is based on mechanical crushing, grinding and/or cutting of the test substance within a flow cell through which extraction fluid is recirculated. The incorporation of a mechanical crushing, cutting and/or grinding step obviates the need for the progressive erosion, vigorous turbulence, ultrasound and grooved extraction chambers described in WO 2010/020752 and WO 2014/033429.

However, it has now been found that the approaches described in WO 2010/020752, WO 2014/033429 and WO 2016/005766 cannot quickly or reliably extract certain solid dosage forms.

Conventionally known in the mining and quarrying arts are various types of rock crusher, including cone, gyratory and jaw crushers. Jaw crushers in these arts conventionally comprise a substantially vertical stationary jaw mounted between machine frames, a movable jaw arranged opposite and diagonally upwards from the lower portion of the stationary jaw, the upper end of said movable jaw being supported by an eccentric axis to give a swivel movement to the upper end portion and a vertical swinging movement to the lower end portion. In operation, stones and rocks are charged into the upper portion of an opening between said two jaws, and then crushed under pressure to smaller pieces by means of the motion of said movable jaw and ultimately discharged as aggregate from a discharge port in the lower portion of the opening.

The present inventors have now discovered that solid dosage forms can be pulverized extremely quickly by using a jaw crusher adapted for use with a solid dosage form sample preparation bag comprising opposed crushing plates.

### SUMMARY

In a first aspect there is provided apparatus for distributing a solid dosage form in an extraction fluid, the apparatus comprising:

(a) a sample preparation bag for containing said solid dosage form and an extraction fluid, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag;

(b) a jaw crusher for pulverizing said solid dosage form contained within the sample preparation bag, the crusher comprising:
(i) an upper pulverizer assembly comprising a pair of opposed jaws, said jaws being moveable relative to one another and each comprising opposed upper and lower crushing surfaces for contacting the outer surfaces of the pulverizing zone of the sample preparation bag and thereby exerting a crushing force on a solid dosage form contained therein via the crusher plates of the bag; and
(ii) a lower pump assembly comprising pumping means comprising a member for contacting an outer surface of the lower reservoir zone of the sample preparation bag and thereby displacing extraction fluid contained therein to the pulverizing zone thereof;
   wherein the opposed upper crushing surfaces are adapted to nip with a first stroke length l₁ and at a first frequency f₁ and the opposed lower faces of the crusher plates are adapted to nip with a second stroke length l₂ at a second frequency f₂, and wherein l₁>l₂ and f₁<f₂.

### Sample Preparation Bag

The crusher plates of the sample preparation bag are preferably substantially rigid. They may be formed of polymer, metal or a composite material. For example, in certain embodiments the crusher plates of the sample preparation bag are formed of reinforced polymer, metal composite or ceramic composite. In particular embodiments, the crusher plates of the sample preparation bag comprise a polypropylene polymer.

The crusher plates of the sample preparation bag may comprise grinding elements disposed on the chamber-proximal surfaces thereof for pulverizing a solid dosage form.

As used herein, the term “grinding element” defines a component of the crusher plate of the sample preparation bag of the invention which comprises means for transmitting crushing forces to a solid dosage form. The grinding elements are typically substantially rigid features of the crusher plate which directly contact a solid dosage form and transmit a concentrated force thereto, facilitating its fragmentation and eventual pulverization. The crushing forces arise from the action of the crushing surfaces of the jaws of the jaw crusher of the invention which bear on areas of the outer surfaces of the walls corresponding to the portions of each of the inner surfaces of the bag to which the crusher plates are fixed.

The grinding element may comprise one or more ribs, recesses, channels, teeth, ridges, spikes, blades or protrusions and it will be appreciated that the nature of the grinding element(s) will depend on the nature of the solid dosage form to be pulverized. In preferred embodiments, the grinding elements are disposed on opposed crusher plates such that they are may intermesh.

Thus, in preferred embodiments the grinding elements comprise intermeshing ridges, teeth, blades or spikes. The grinding elements may be adapted to size screen pulverized solid dosage form such that particles above a threshold size are retained within the upper reservoir and/or pulverising zone(s) while smaller particles pass through the grinding elements into the lower reservoir zone of the sample preparation bag.

The opening of the sample preparation bag is conveniently reversibly sealable to facilitate staged introduction of dosage forms and/or extraction fluid (or aliquots thereof).

In certain embodiments, the volume of the upper reservoir pulverizing zone of the sample preparation bag is less than that of the lower reservoir zone thereof. For example, the volume of the upper reservoir zone of the sample preparation bag may be selected from: 1-200 ml; 2-200 ml; 5-200 ml; 5-150 ml; 10-100 ml; and 10-75 ml. In certain embodiments, the volume of the lower reservoir zone of the sample preparation bag may be selected from: 1-1000 ml; 2-1000 ml; 5-1000 ml; 10-1000 ml; 20-1000 ml; 50-1000 ml; 50-750 ml; and 50-500 ml.

The flexible walls of the sample preparation bag are preferably transparent or translucent. In certain embodiments, the flexible walls of the sample preparation bag are formed of polyethylene or polypropylene.

The sample preparation chamber of the sample preparation bag may have a volume selected from: 1-1000 ml; 10-1000 ml; 20-500 ml; and 20-150 ml.

The sample preparation bag may contain one or more solid dosage forms and/or an extraction fluid, for example an aqueous solvent. In certain embodiments, the sample preparation bag contains one or more solid dosage forms and an extraction fluid therefor, for example being a solvent.

### Pump Assembly

The pumping means of the lower and/or upper pump assembly may comprise means for compressing the flexible walls of the sample preparation bag. In certain embodiments,

the compressing means is a moveable plate or a roller, but any suitable compressing means may be employed.

In embodiments where the pump is a roller, the pump assembly may take the form of apparatus for agitating a liquid sample, as described in more detail below.

Preferably, the compressing means is adapted to displace a predetermined and variable volume of extraction fluid. For example, the compressing means may be adapted to displace a predetermined and variable volume of extraction fluid at a rate of: 1-120; 2-60; or 10-30 displacements per minute.

The apparatus may further comprise an upper pump assembly comprising pumping means comprising a member for contacting an outer surface of the upper reservoir zone of the sample preparation bag and thereby displacing extraction fluid contained therein to the pulverizing zone thereof.

### Roller Pump Apparatus for Use According to the Invention

The pump assembly may comprise apparatus for agitating a liquid sample comprising:

(a) a frame for holding the sample preparation bag;

(c) an agitator assembly comprising a roller adapted to roll over an outer surface of a flexible wall of the sample preparation bag and to exert a rolling pressure thereon, whereby a portion of the bag is compressed such that part of the liquid sample is displaced and forced to flow within the bag, under and/or around the roller, so agitating it within the sample chamber; and

(d) a motor operably coupled to said agitator assembly and/or to said frame for reciprocating the roller relative to the bag.

In such embodiments, the sample preparation bag is referred to as an extraction pouch. The extraction pouch comprises walls defining a chamber in which a liquid sample is confined, the pouch comprising a pair of opposed walls, at least one of which is flexible.

The flexible walls of the extraction pouch are preferably transparent or translucent, to permit visual inspection of the liquid sample. In certain embodiments, the flexible walls of the extraction pouch are formed of polyethylene or polypropylene.

The liquid sample in the pouch chamber may be of any volume, but in most embodiments it has a volume within the following ranges: 1-1000 ml; 2-1000 ml; 5-1000 ml; 10-1000 ml; 25-500 ml; 20-1000 ml; 50-1000 ml; 50-750 ml; 50-500 ml; 1-100 ml; 1-5 ml; 1-10 ml or 1-25 ml.

### Agitating Assembly

The agitating assembly may comprise a reciprocating roller adapted to roll over an outer surface of said flexible wall of the extraction pouch and to exert a rolling pressure thereon, whereby a portion of the pouch is compressed such that part of the liquid sample is displaced and forced to flow within the extraction pouch, under and/or around the compressed portion of the extraction pouch under the roller, so agitating it within the sample chamber.

### Fixed Rollers

The roller for use in the agitating assembly of the invention may be a fixed roller. As used herein, the term “fixed roller” defines a roller which is adapted to roll over the outer surface of the extraction pouch at a constant rolling height. As used herein, the term “rolling height” applies in relation to all rollers for use according to the invention (including fixed, lifting, nip, gapped and profiled rollers) and defines the distance between the opposed walls of the extraction pouch when under rolling pressure.

In embodiments where the frame further comprises a support surface for supporting the wall opposed to the flexible wall of the extraction pouch subject to rolling pressure, the rolling height may also define the distance between the support surface and the roller.

The rolling height of a fixed roller may be adjustable by the user. For example, the apparatus of the invention may comprise a roller height adjustment means for adjusting the rolling height of a fixed roller. Such rollers are herein referred to as adjustable rollers.

### Lifting Rollers

The roller for use in the agitating assembly of the invention may be a lifting roller. As used herein, the term “lifting roller” defines a roller which is adapted to roll over the outer surface of the extraction pouch at a rolling height which is not constant.

As previously explained, the rolling height defines the distance between the opposed walls of the extraction pouch when under rolling pressure, and in embodiments where the frame further comprises a support surface for supporting the wall opposed to the flexible wall of the extraction pouch subject to rolling pressure, the rolling height may also define the distance between the support surface and the lifting roller.

Lifting rollers therefore include rollers adapted to roll over the outer surface of the extraction pouch at a rolling height which varies continuously as the roller rolls over the outer surface of the flexible wall of the extraction pouch.

Lifting rollers therefore include rollers adapted to roll over the outer surface of the extraction pouch at a rolling height which is determined (at least in part) by the hydrostatic pressure of the liquid sample within the compressed portion of the extraction pouch under the roller.

Lifting rollers also include rollers adapted to roll over the outer surface of the extraction pouch at a rolling height which is determined (at least in part) by the presence of solids within the liquid sample. For example, lifting rollers include rollers adapted to lift when passing over solid particles or highly viscous components within the liquid sample.

Thus, both fixed and lifting rollers for use in the agitating assembly of the invention may function as nip and gapped rollers, as described below. Moreover, in some embodiments a lifting roller may function as both a nip and a gapped roller when in use, depending on the rolling height, since the rolling height in such embodiments (as explained above) may vary as the roller rolls over the outer surface of the flexible wall of the extraction pouch (being determined inter alia by the hydrostatic pressure of the liquid sample within the compressed portion of the extraction pouch under the roller and/or the presence of solid or highly viscous components within the sample).

### Nip Rollers

In certain embodiments, the agitating assembly of the invention comprises a nip roller. As used herein, the term “nip roller” defines a roller adapted to roll over the outer surface of the extraction pouch at a rolling height at which the opposed walls of the extraction pouch are brought into contact when under rolling pressure. Thus, a nip roller is configured such that it brings the inner surface of said flexible wall into contact with the inner surface of the opposed wall of the extraction pouch. The rolling pressure of a nip roller therefore excludes all liquid from the compressed portion of the extraction pouch under the roller, so that part of the liquid sample is displaced and forced to flow away (for example around) the compressed portion of the extraction pouch under the roller.

### Gapped Rollers

In certain embodiments, the roller is a gapped roller. As used herein, the term “gapped roller” defines a roller adapted to roll over the outer surface of the extraction pouch at a rolling height at which the opposed walls of the extraction pouch are not brought into contact when under rolling pressure, but remain spaced apart by a gap which permits the liquid sample to flow in the compressed portion of the extraction pouch under the roller. The rolling pressure of a gapped roller is therefore insufficient to bring the flexible wall of the extraction pouch into contact with the opposed wall. A gapped roller is therefore configured such that it does not bring the inner surface of said flexible wall into contact with the inner surface of the opposed wall (so that a gap between the walls and under the roller is maintained). A gapped roller therefore permits a flow of liquid sample between the compressed walls of the portion of the pouch under the roller, so that part of the liquid sample may be displaced and forced to flow both under and around the compressed portion of the extraction pouch under the roller.

The use of such a gapped roller may reduce or eliminate bag fatigue and/or failure and may also find particular application when the liquid is (at least prior to agitation) non-homogeneous, containing solids (for example in particulate form).

Agitating assemblies comprising a gapped roller may further comprise means for generating a pressure on the portion of the outer surface of said flexible wall by the roller. Suitable means for generating pressure include those comprising a weight, a coiled spring, a lever spring, gas spring, hydraulic strut, solenoid, servo-motor or stepper-motor.

### Profiled Rollers

The roller for use in the agitating assembly of the invention may be a profiled roller. As used herein, the term “profiled roller” defines a roller comprising a tread adapted to roll over the outer surface of the extraction pouch, which roller tread comprises grooves and/or or ribs (i.e. the roller comprises a grooved and/or ribbed cylindrical portion). In such embodiments, the cylinder may comprise circumferential and/or longitudinal grooves or ribs.

### Multiple Rollers

The agitating assembly of the invention may comprise a plurality of rollers. In such embodiments, the rollers may comprise a combination of:

(a) two or more fixed rollers; and/or

(b) two or more lifting rollers; and/or

(c) two or more gapped rollers; and/or

(d) two or more nip rollers.

In such embodiments, the rollers may comprise a combination of at least one fixed roller and at least one lifting roller.

In embodiments where the rollers comprise a combination of two or more fixed rollers, one or more of the rollers may be adjustable rollers, and may be independently adjustable.

The rollers may comprise a combination of at least one nip roller and at least one gapped roller. In such embodiments, the nip and/or gapped roller may be fixed or lifting.

In some embodiments, the agitating assembly of the invention may comprise a plurality of lifting rollers, for example a plurality of gapped, lifting rollers.

In a preferred embodiment, the agitating assembly comprises a plurality of rollers (for example, gapped and/or lifting rollers) spaced apart on a common spindle. Here, the rollers may comprise 2-8, 2-6 or 2-4 rollers spaced apart on a common spindle.

In such embodiments, each roller may be a nip roller, a gapped roller or a combination of nip and gapped rollers. In each case, the rollers may be fixed or lifting. In such embodiments, the rollers permits a flow of liquid sample between the rollers in the uncompressed portions of the pouch under the spaces between the rollers, so that part of the liquid sample may be displaced and forced to flow between them.

### Motor

The roller pump apparatus comprises a motor operably coupled to said agitator assembly and/or to said frame for reciprocating the roller relative to the extraction pouch.

Any form of motor may be employed provided that sufficient force is generated to move the pouch relative to the roller such that it rolls over an outer surface of said flexible wall of the extraction pouch and exerts a rolling pressure thereon.

The motor may further comprise a programmable controller for actuating movement of the roller, and may permit user-controlled values for roller speed, roller pressure and/or reciprocations per minute. For example, the roller may reciprocate at a rate of: 1-120 strokes per minute, for example 2-60 strokes per minute. The reciprocation may be continuous or pulsed.

In preferred embodiments, the roller operation parameters are selected by the operator by reference inter alia to the volume of the liquid sample, the volume of the liquid sample chamber, the nature of the liquid sample, its viscosity and the effects of agitation on the foregoing characteristics.

### Frame

The roller pump apparatus comprises a frame for holding said extraction pouch. Any suitable frame may be employed, provided that it allows the extraction pouch to be moved relative to the rollers of the agitating assembly.

In preferred embodiments, the frame further comprises retaining means which immobilizes the entire periphery of the pouch within the frame.

### Pulverizer Assembly

The opposed upper crushing surfaces are adapted to nip with a first stroke length l₁ and at a first frequency f₁ and the opposed lower faces of the crusher plates are adapted to nip with a second stroke length l₂ at a second frequency f₂, and wherein l₁>l₂ and f₁<f₂.

It will be appreciated that the first stroke length will be determined according to the size of the solid dosage form to be processed. However, in preferred embodiments, l₁ is greater than 2 mm, 3 mm, 4 mm, 5 mm or 6 mm.

It will also be appreciated that f₁ can be selected according to the nature of the solid dosage form to be processed, including its hardness and composition, and the speed of pulverization required. In certain embodiments f₁ may be at least 30, 50, 100, 200, 250 or 300 strokes per minute.

It will also be appreciated that f₁ can be selected according to the nature of the solid dosage form to be processed, including its hardness and composition, as well as the degree of pulverization/particle size and speed of pulverization required. In certain embodiments, f₂ may be greater than 100, 300, 500, 1000, 2000, 2500 or 3000 or up to 10000 strokes per minute.

In preferred embodiments, the upper pulverizer assembly of the jaw crusher further comprises a frame member to which the jaws are attached. Conveniently, one of the jaws may be fixed immovable to the frame while the other jaw is moveably fixed thereto. However, any suitable arrangement is possible provide that the jaws are moveable relative to one another: for example, both jaws may be moveably fixed to the frame.

In certain embodiments, at least one moveable jaw is fixed to the frame by one or more eccentric shafts. In particularly preferred embodiments, at least one moveable jaw is fixed to the frame by two eccentric shafts. In such embodiments, the two eccentric shafts may comprise an upper shaft, rotation of which causes the opposed upper crushing surfaces to nip with said first stroke length l₁ and at said first frequency f₁. In certain such embodiments, the two eccentric shafts comprise a lower shaft, rotation of which causes the opposed lower faces of the crusher plates to nip with said second stroke length l₂ at said second frequency f₂.

The apparatus preferably further comprises a programmable controller for actuating movement of the jaw(s) and/or the pumping means. In particular, the controller may control the first stroke length l₁ and/or the first frequency f₁ and/or the second stroke length l₂ and/or the second frequency f₂ and/or the displacement volume and/or displacement frequency of the pumping means of the pump assembly.

In a second aspect, there is provided a sample preparation bag for containing said solid dosage form and an extraction fluid, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag.

The sample preparation bag according to the second aspect may be as defined above.

In a third aspect, there is provided a jaw crusher for pulverizing a solid dosage form contained within a sample preparation bag as herein defined, the crusher comprising:
(i) an upper pulverizer assembly comprising a pair of opposed jaws, said jaws being moveable relative to one another and each comprising opposed upper and lower crushing surfaces for contacting the outer surfaces of the pulverizing zone of the sample preparation bag and thereby exerting a crushing force on a solid dosage form contained therein via the crusher plates of the bag; and
(ii) a lower pump assembly comprising pumping means comprising a member for contacting an outer surface of the lower reservoir zone of the sample preparation bag and thereby displacing extraction fluid contained therein to the pulverizing zone thereof;
   wherein the opposed upper crushing surfaces are adapted to nip with a first stroke length l₁ and at a first frequency f₁ and the opposed lower faces of the crusher plates are adapted to nip with a second stroke length l₂ at a second frequency f₂, and wherein l₁>l₂ and f₁<f₂.

The jaw crusher according to the third aspect may be as defined above.

In a fourth aspect, there is provided a method for pulverising a solid dosage form comprising the steps of:

(a) placing one or more solid dosage form(s) within a sample preparation bag as defined above; and

(b) crushing the dosage form(s) by applying force to the crusher plates of the bag to pulverize the dosage form(s).

Here, step (b) may be performed by placing the bag containing the dosage form(s) in an upper pulverizer assembly as defined herein.

In a fifth aspect, there is provided a method for distributing a solid dosage form in an extraction fluid comprising the steps of:

(a) placing one or more solid dosage form(s) and an extraction fluid within a sample preparation bag as defined herein;

(b) recirculating extraction fluid containing the dosage form(s) between the upper and lower reservoir zones of the sample preparation bag.

In a sixth aspect, there is provided a method for distributing a solid dosage form in an extraction fluid comprising the steps of:

(a) placing one or more solid dosage form(s) and an extraction fluid within a sample preparation bag as defined herein;

(b) crushing the dosage form(s) by applying force to the crusher plates of the bag to pulverize the dosage form(s); and

(c) distributing the pulverized dosage form(s) of step (b) in the extraction fluid.

Here, in step (a) the extraction fluid may be placed within the sample preparation bag prior to, simultaneously with or after step (b).

In the above methods, step (b) may be performed prior to, simultaneously with or after step (c).

The methods may further comprise the step of recirculating extraction fluid containing pulverized dosage form(s) between the upper and lower reservoir zones of the sample preparation bag. Steps (b) and (c) may be performed by placing the bag containing the dosage form(s) and optionally the extraction fluid between the jaws of a jaw crusher as defined herein.

In a seventh aspect, there is provided a process for producing a pulverized solid dosage form comprising pulverising the solid dosage form(s) according to a method as defined herein.

In an eighth aspect, there is provided a process for producing a solid dosage form distributed in an extraction fluid comprising distributing the solid dosage form(s) according to a method as defined herein.

Any solid dosage form may be pulverized (and optionally dissolved and/or suspended in an extraction fluid) according to the invention, including but not limited to pharmaceutical solid dosage forms (including solid oral dosage forms, for example pills, capsules, lozenges and tablets), dietary supplement dosage forms, pelleted feedstuffs, environmental samples, cosmetics, herbal extracts, pesticides, fertilizers, laboratory reagents and indeed to any composition which is in a solid unit dose form.

In preferred embodiments, the solid dosage form is a pharmaceutical solid dose form. Here, the pharmaceutical solid dose form may be a slow-release, sustained release, prolonged release, hard-compacted or tamper-proof dosage form.

In other embodiments, the solid dosage form may comprise: (a) an environmental sample; (b) a cosmetic sample; (c) a herbal extract sample; (d) a laboratory reagent sample; (e) a food sample; (f) a nutraceutical sample; (g) a dietary supplement sample; (h) an agrochemical sample; (i) a veterinary product sample; (j) a fine chemical sample; (k) a waste sample (e.g. an environmental waste sample); (l) a tobacco sample; or (m) a stimulant composition sample.

### BRIEF DESCRIPTION OF THE DRAWINGS

Embodiments of the present invention will now be described by way of example with reference to the accompanying drawings in which:

FIG. 1A is a plan view of a sample preparation bag according to the invention.

FIG. 1B is a cross-sectional side view of the sample preparation bag shown in FIG. 1A.

FIGS. 2A-2D are perspective views illustrating four different embodiments (A-D) of a crusher plate according to the invention showing the grinding elements.

FIGS. 3A and 3B are plan views of two further embodiments of a sample preparation bag according to the invention.

FIG. 4 is a side plan view of a jaw crusher according to the invention showing the upper pulverizer assembly shown in FIG. 5 coupled to the lower pump assembly shown in FIG. 6.

FIG. 5 is a side plan view of an upper pulverizer assembly of a jaw crusher according to the invention showing the crusher jaws.

FIG. 6 is a side plan view of a lower pump assembly of a jaw crusher according to the invention showing the pumping means.

FIG. 7 is a side plan view of an apparatus according to the invention, showing the jaw crusher shown in FIG. 4 loaded with a sample preparation bag containing solid dosage forms and an extraction fluid.

FIG. 8 illustrates a side plan view of the apparatus shown in FIG. 7 being used to crush solid dosage forms showing the pulverizing action of the upper crushing surfaces of the jaws.

FIG. 9 illustrates a side plan view of the apparatus shown in FIG. 7 being used to crush solid dosage forms showing the pulverizing action of the lower crushing surfaces of the jaws.

FIGS. 10A-10C illustrate side plan views of the apparatus shown in FIG. 7 being used to crush solid dosage forms showing the pumping action of the pumping means, illustrating a member contacting an outer surface of the lower reservoir zone c of a sample preparation bag and moving to displace extraction fluid contained therein through the pulverizing zone b and into the upper reservoir zone a thereof.

FIG. 11 is a perspective schematic view of a roller pump apparatus for use with the apparatus of the invention.

### DETAILED DESCRIPTION OF CERTAIN INVENTIVE EMBODIMENTS

### Sample Preparation Bag

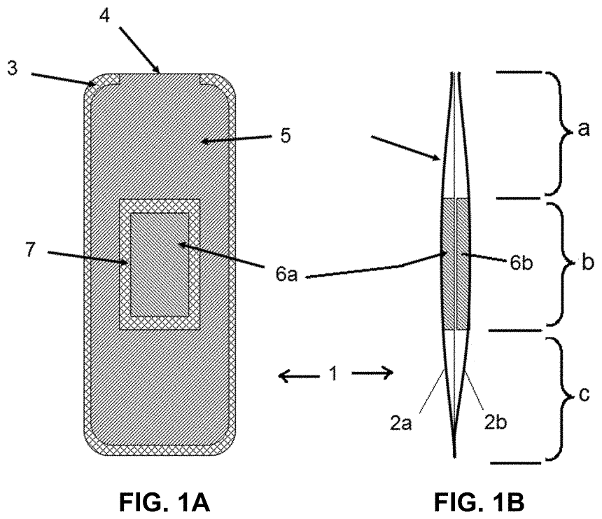

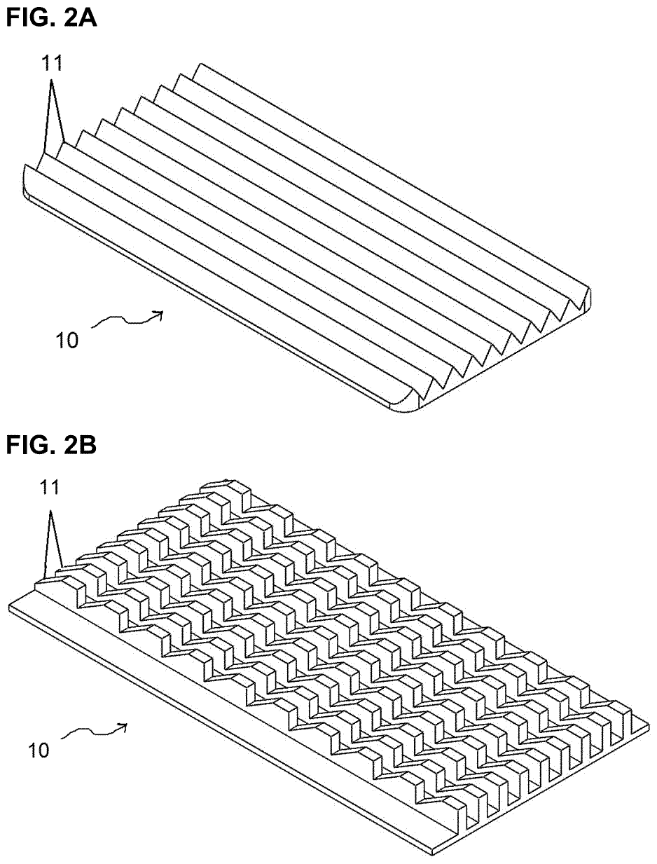

Referring now to FIG. 1, the sample preparation bag 1 is formed of two opposed transparent polyethylene membranes 2a and 2b welded (shown as a hatched area) at the periphery to form a perimeter seal 3 with a portion left unsealed to form a resealable opening 4. The membranes 2a and 2b therefore serve as flexible walls defining a sample preparation chamber 5.

A pair of opposed crusher plates 6a and 6b are heat welded to a portion of each of the inner surfaces of the opposing walls of the bag (shown as a hatched area) such that each crusher plate is fixed to the inner surface of the sample preparation chamber by a perimeter seal 7.

The sample preparation chamber 5 therefore comprises: (i) an opening-proximal upper reservoir zone a for receiving one or more solid dosage forms via the opening; (ii) an opening-distal lower reservoir zone c for containing pulverized solid dosage form and/or extraction fluid; and (iii) a pulverizing zone b between the upper and lower reservoir zones.

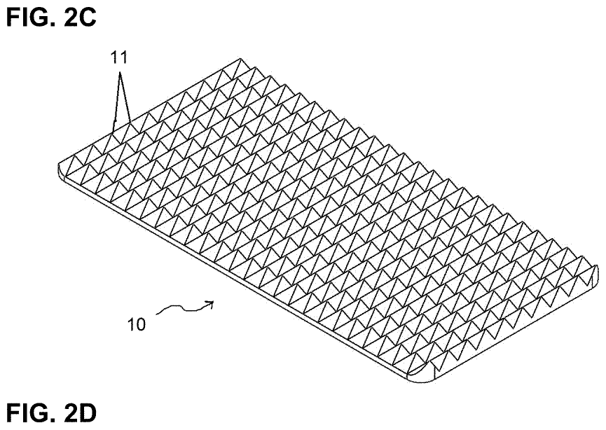

The crusher plates are formed of injection moulded hard plastic (polypropylene) and four different crusher plate embodiments (A-D) are shown in more detail in FIG. 2.

FIG. 2A shows one of a pair of opposed crusher plates 10 having a plurality of grinding elements 11 in the form of sharp ridges arranged in parallel along the length of the plate. The grinding elements 11 intermesh with corresponding ridges on the other, opposed, plate of the pair (not shown).

Referring now to FIG. 2B (and using the numbering for the components of the crusher plate adopted in the description of FIG. 2A), this shows one of a pair of opposed crusher plates 10 having a plurality of grinding elements 11 in the form of teeth arranged in parallel rows along the length of the plate. The grinding elements 11 intermesh with corresponding rows of teeth on the other, opposed, plate of the pair (not shown).

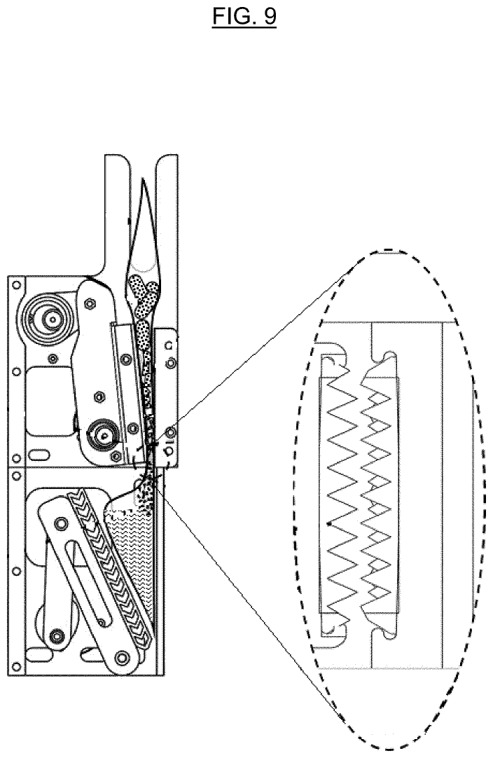

Referring now to FIG. 2C (and using the numbering for the components of the crusher plate adopted in the description of FIG. 2A), this shows one of a pair of opposed crusher plates 10 having a plurality of grinding elements 11 in the form of spikes arranged in parallel rows along the length of the plate. The grinding elements 11 intermesh with corresponding rows of spikes on the other, opposed, plate of the pair, as shown in the magnified area of FIG. 9.

Referring now to FIG. 2D (and using the numbering for the components of the crusher plate adopted in the description of FIG. 2A), this shows one of a pair of opposed crusher plates 10 having a plurality of grinding elements 11 in the form of variegated sharp ridges arranged in parallel rows along the length of the plate. The ridges are arranged in three different bands, an upper (bag-opening-proximal) band, a middle band and a lower (bag-opening-distal) band of progressively sharper and closely-spaced ridges. The grinding elements 11 intermesh with corresponding variegated ridges on the other, opposed, plate of the pair (not shown).

It will be understood that in this embodiment, the grinding elements function to size screen the fragments of solid dosage form produced during crushing such that larger fragments are retained within the upper band while progressively smaller fragments make their way down past the middle band, into the lower band and eventually past the crusher plate to exit the pulverizing zone and enter the lower reservoir zone c of the sample preparation chamber in a pulverized state.

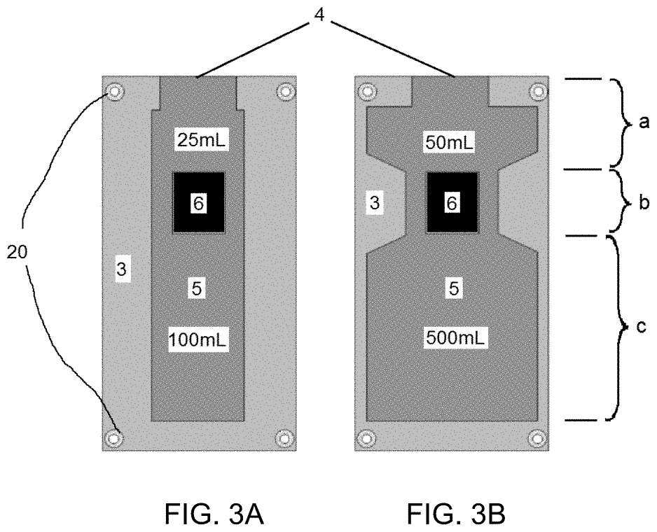

Referring now to FIG. 3 (and using the numbering for the components of the sample preparation bag adopted in the description of FIG. 1), this shows two yet further embodiments (A and B) of a sample preparation bag according to the invention. The sample preparation bags of these embodiments further comprise locating holes 20 within the perimeter seal 3 (shown in light grey), which engage with pins in a jaw crusher (not shown) to support the bag when loaded into the jaw crusher.

The sample preparation chamber 5 (dark grey) comprises: (i) an opening-proximal upper reservoir zone a for receiving one or more solid dosage forms via the opening; (ii) an opening-distal lower reservoir zone c for containing pulverized solid dosage form and/or extraction fluid; and (iii) a pulverizing zone b between the upper and lower reservoir zones. The crusher plate 6 (black) separates the zones a and c. In these embodiments the upper reservoir zone a is of a small volume relative to the lower reservoir zone c.

FIG. 3A shows a bag adapted for relatively small quantities of extraction fluid, having a 25 ml upper reservoir zone a and a 100 ml lower reservoir zone c.

FIG. 3B shows a bag adapted for relatively large quantities of extraction fluid, having a 50 ml upper reservoir zone a and a 500 ml lower reservoir zone c.

### Jaw Crusher

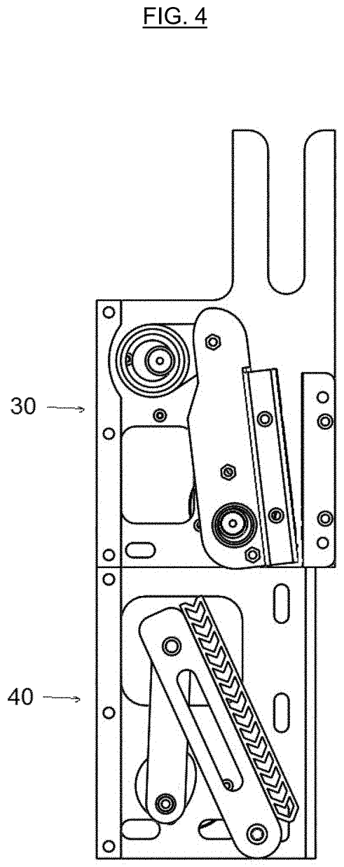

The jaw crusher of the invention is illustrated in FIG. 4 and comprises an upper pulverizer assembly 30 and a lower pump assembly 40. FIG. 4 is best apprehended by considering each of the upper and lower assemblies in turn:

### Upper Pulverizing Assembly

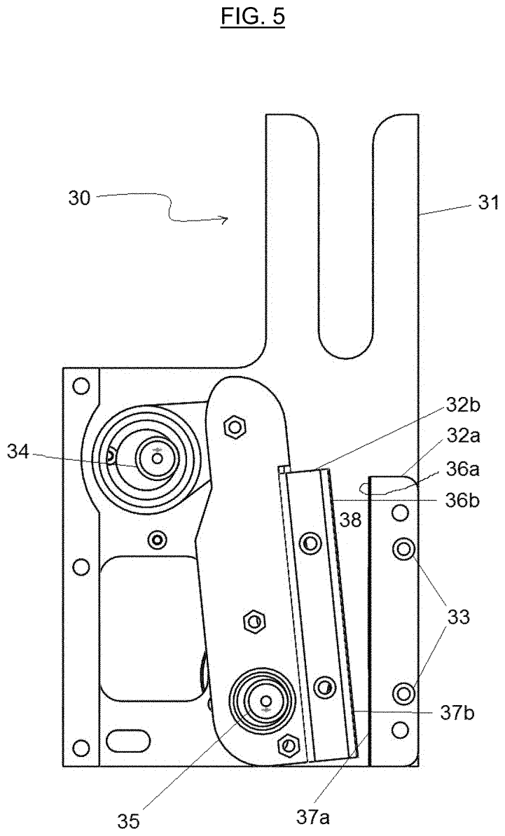

FIG. 5 illustrates an upper pulverizing assembly of a jaw crusher of the invention. The assembly 30 comprises a frame 31 to which is fixed a stationary jaw 32a by bolts 33. A second, moveable, opposed jaw 32b is mounted in the frame 31 by upper eccentric shaft 34 and lower eccentric shaft 35. The upper eccentric shaft 34 produces a stroke length which is greater than that of the lower eccentric shaft 35.

The jaws 32a and 32b have upper (36a, 36b) and lower (37a, 37b) crushing surfaces and are located within the frame 31 at an angle such that their crushing surfaces define a wedge-shaped crushing chamber 38. The lower, thin part of the wedge-shaped crushing chamber 38 is bounded by side walls (not shown) and the lower crushing surfaces (37a, 37b) of the jaws 32a, 32b, while the upper, thick part of the wedge-shaped crushing chamber 38 is bounded by side walls (not shown) and the upper crushing surfaces (36a, 36b) of the jaws 32a, 32b.

### Lower Pump Assembly

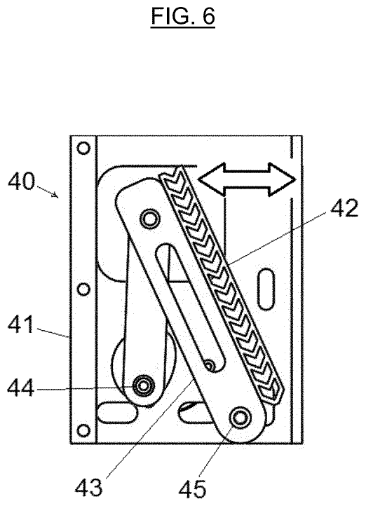

FIG. 6 illustrates a lower pump assembly of a jaw crusher of the invention. The assembly 40 comprises a frame 41 to which is mounted a pumping paddle 42 for contacting an outer surface of the lower reservoir zone c of a sample preparation bag and thereby displacing extraction fluid contained therein upwards and into the pulverizing zone thereof. The pumping paddle 42 is mounted on a pivot arm assembly 43 mounted in the frame by shafts 44 and 45 such that the paddle rocks within the frame in the directions indicated by the arrows.

### Operation

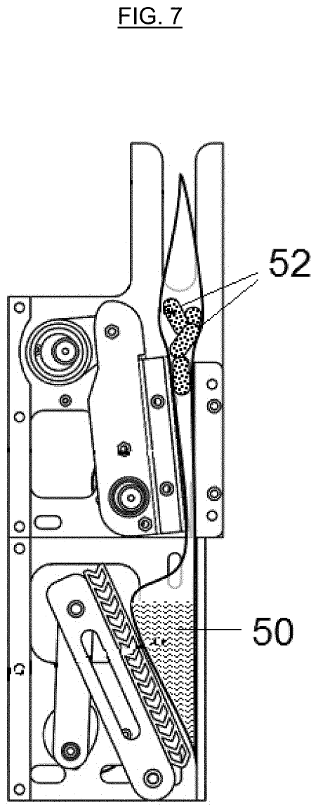

Referring to FIGS. 1 and 7 (and using the numbering for the components of the sample preparation bag adopted in the description of FIG. 1), the resealable opening 4 is opened and extraction fluid 50 (50 ml of methanol) is introduced into the sample preparation chamber 5 of a sample preparation bag 1 via opening 4. The fluid flows past the crusher plates 6a and 6b (for clarity, not shown in FIG. 7) into the lower reservoir zone c of the sample preparation chamber 5.

Next, four tablets 52 introduced into the sample preparation chamber 5 of the sample preparation bag 1 via opening 4. The opening 4 is then resealed. The tablets are retained within the upper reservoir zone a and upper section of the pulverizing zone b by the crusher plates 6a and 6b (for clarity, not shown in FIG. 7) which block the passage of unfragmented tablets into the lower reservoir zone c of the sample preparation chamber 5.

Referring now to FIG. 7 (and using the numbering for the components of the jaw crusher adopted in the description of FIGS. 4-6), the sample preparation bag 1 containing the tablets 50 is loaded into the jaw crusher such that the pulverizing zone b is located in the crushing chamber 38 and the lower reservoir zone c is located in the lower pump assembly 40.

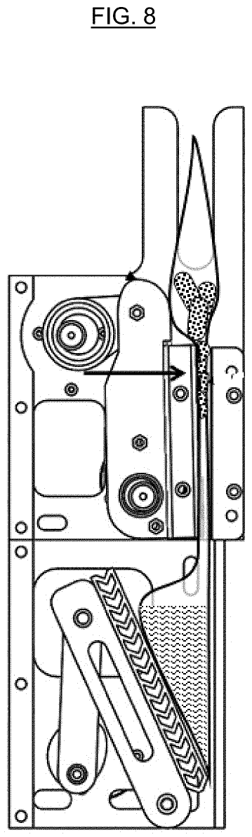

Referring now to FIG. 8 (and again using the numbering for the components of the jaw crusher adopted in the description of FIGS. 4-6), rotation of the upper eccentric shaft 34 causes the jaws to nip, driving the opposed upper crushing surfaces (36a, 36b) towards each other to begin the process of crushing the tablets between the crusher plates (not shown) within the bag 1. This initial coarse crushing action is shown by the arrow in FIG. 8. As the tablets are fragmented by the nipping action of the upper crushing surfaces (36a, 36b), small fragments work their way down towards the lower crushing surfaces (37a, 37b).

Referring now to FIG. 9 (and again using the numbering for the components of the jaw crusher adopted in the description of FIGS. 4-6), rotation of the lower eccentric shaft 35 causes the jaws to nip, driving the opposed lower crushing surfaces (37a, 37b) towards each other to complete the process of crushing the tablets between the crusher plates (not shown) within the bag 1 to generate pulverized tablets. This fine pulverizing action occurs at the region shown magnified in FIG. 9, where the magnified area shows the crusher plates (not shown in the unmagnified view) in cross section looking down towards the lower reservoir zone c. Intermeshing grinding elements on the crusher plates function to size screen the fragments of solid dosage form produced during crushing such that larger fragments are retained within the upper band while progressively smaller fragments make their way down past the middle band, into the lower band and eventually past the crusher plate to exit the pulverizing zone b and enter the extraction fluid 50 in the lower reservoir zone c of the sample preparation chamber in a pulverized state (shown as a granular cascade emerging from the pulverizing zone and falling into the extraction fluid 50 in FIG. 9). The pulverized tablets then begin to dissolve in the extraction fluid.

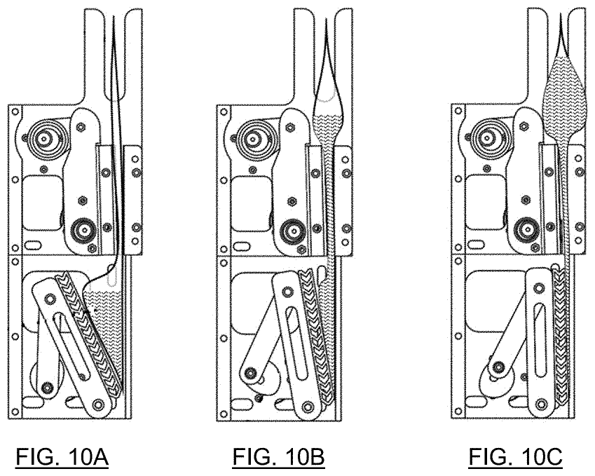

The coarse and fine pulverizing action of the upper pulverizing assembly 30 described above is supplemented by a recirculation of extraction fluid 50 by the lower pump assembly 40, as shown in FIG. 10 (and using the numbering for the components of the pump assembly adopted in the description of FIG. 6).

FIGS. 10A-C illustrates how the progressive movement of the pumping paddle 42 displaces extraction fluid (containing dissolved and/or dispersed tablets) upwards, washing through the pulverizing zone b and into the upper reservoir zone a. The stroke and frequency of the pumping paddle 42 is controlled by a programmable controller (not shown) and can be varied to drive a predetermined volume of the extraction fluid past the pulverizing zone b and into the upper reservoir zone a. In some applications, the stroke of the pumping paddle 42 is selected so as to merely wash the pulverizing zone b, without driving extraction fluid into the upper reservoir zone a.

It will therefore be appreciated that the actions of: (a) a coarse crushing at the opposed upper crushing surfaces (36a, 36b); (b) a fine pulverizing action at the opposed lower crushing surfaces (37a, 37b); and (c) a recirculation of extraction fluid between upper and lower reservoir zones a and c (so washing through the pulverizing zone b) can act in concert to very rapidly pulverize and dissolve the solid tablets in extraction fluid for subsequent analysis. The pulverised tablets are ultimately dissolved, suspended and/or distributed throughout the extraction fluid.

In some cases the tablets are pulverized prior to the introduction of the extraction fluid. Such a “dry” pulverizing operation may be preferred when a particular type of dosage form formulation extracts more effectively in a powdered form. In this case, the extraction fluid may be introduced after the pulverizing process is complete so that pulverized material is allowed to dissolve in extraction fluid.

The duration and nature of the various operations described above may be controlled by the operator and varies according to the solid dosage form to be extracted. The relative timings and frequency of the coarse crushing, pulverizing and recirculation operations are also controlled by the operator and vary according to the dosage form to be extracted.

Control of these operations is typically via a programmable controller (not shown). This actuates movement of the moveable jaw 32b and can be programmed to control rotation about the upper eccentric shaft 34 and lower eccentric shaft 35, thereby permitting the user to adapt the coarse and fine pulverizing action of the crusher jaws to the particular solid dosage form being processed. The controller can also be programmed to control operation of the pumping paddle 42.

The performance of the apparatus of the invention was compared to that of apparatus as described in WO 2016/005766, WO 2010/020752 and WO 2014/033429 (prior art). Extraction of multiple tablets of the solid dosage forms of hydroxypropylmethylcelulose (HPMC) or Polyethylene oxide (PEO) with the apparatus of the present invention was orders of magnitude faster than with that described in the prior art.

### Roller Pump Apparatus

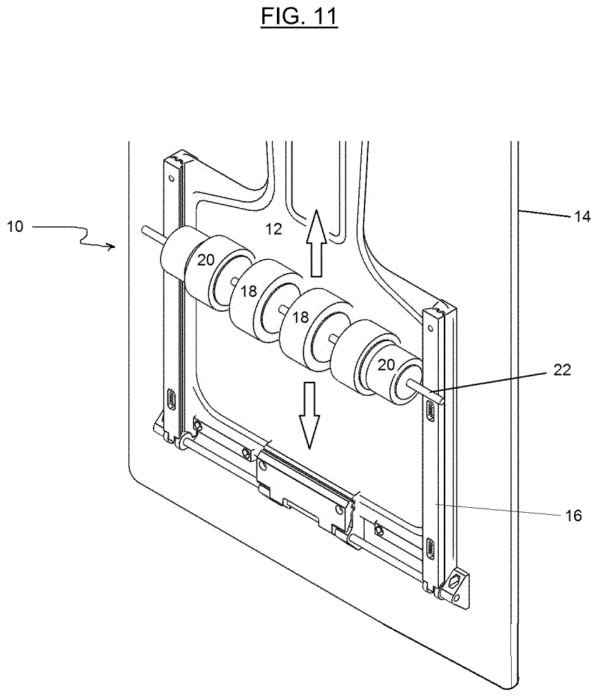

Referring now to FIG. 11, the apparatus 10 comprises an extraction pouch having flexible walls 12 containing a liquid sample (not shown) mounted on a frame 14 by peripheral clamps 16. An agitator assembly comprising inner and outer rollers (18 and 20, respectively) mounted, in a spaced apart configuration, on a common spindle 22 and operably coupled to a motor (not shown) are positioned to roll over an outer surface of said flexible wall of the extraction pouch in the directions indicated by the arrows when the spindle 22 is reciprocated by the motor. Outer rollers 20 are of smaller radius than the inner rollers, and so serve as gapped rollers. The inner rollers 18 are configured to bear down onto the surface of the pouch with a pressure provided by coil springs (not shown), and therefore act as lifting rollers, serving as both gapped and nip rollers (as explained below).

### Operation

Referring again to FIG. 11, extraction pouch 12 is loaded onto the frame 14 by tightening the clamps 16 such that three sides of the pouch 12 are securely fixed onto the frame 14.

The resealable opening (not shown) in the extraction pouch 12 is then opened and the liquid sample (not shown) is introduced into the chamber of the pouch via the opening. The opening is then resealed.

Activation of the motor (not shown) causes reciprocation of the spindle 22, so causing the rollers 18 and 20 to roll over outer surfaces of the flexible walls of the extraction pouch in the directions indicated by the arrows. Portions of the pouch underlying the rollers are thereby compressed, so that portions of the liquid sample confined therein are displaced and forced to flow: (a) under and around the rollers 20; and (b) around the rollers 18 (and also under them, when the hydrostatic pressure of the compressed portion of the fluid sample under the rollers exceeds the pressure generated by the coil springs).

Repeated reciprocation of the spindle therefore induces rapid flow of the bulk liquid sample both under and between the rollers (18, 20), so vigorously agitating the liquid sample within the sample chamber.

The foregoing description details presently preferred embodiments of the present invention which are therefore to be considered in all respects as illustrative and not restrictive. Those skilled in the art will recognize, or be able to ascertain, using no more than routine experimentation, many equivalents, modifications and variations to the specific embodiments of the invention described specifically herein. Such equivalents, modifications and variations are intended to be (or are) encompassed in the scope of the following claims.

What is claimed is:

1. Apparatus for distributing a solid dosage form in an extraction fluid, the apparatus comprising:
(a) a sample preparation bag for containing said solid dosage form and an extraction fluid, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag;
(b) a jaw crusher for pulverizing said solid dosage form contained within the sample preparation bag, the crusher comprising:
(i) an upper pulverizer assembly comprising a pair of opposed jaws, said jaws being moveable relative to one another and each comprising opposed upper and lower crushing surfaces for contacting the outer surfaces of the pulverizing zone of the sample preparation bag and thereby exerting a crushing force on a solid dosage form contained therein via the crusher plates of the bag; and
(ii) a lower pump assembly comprising pumping means comprising a member for contacting an outer surface of the lower reservoir zone of the sample preparation bag and thereby displacing extraction fluid contained therein to the pulverizing zone thereof;
wherein the opposed upper crushing surfaces are adapted to nip with a first stroke length l₁ and at a first frequency f₁ and the opposed lower crushing surfaces are adapted to nip with a second stroke length l₂ at a second frequency f₂, and wherein l₁>l₂ and f₁21 f₂.

2. The apparatus of claim 1 wherein the crusher plates of the sample preparation bag: (a) are substantially rigid; (b) are formed of polymer, metal or a composite material; (c) are formed of reinforced polymer, metal composite or ceramic composite; or (d) comprise a polypropylene polymer.

3-5. (canceled)

6. The apparatus of claim 1, wherein the crusher plates of the sample preparation bag comprise grinding elements disposed on the chamber-proximal surfaces thereof for pulverizing a solid dosage form, wherein the grinding elements comprise intermeshing ridges, teeth, blades or spikes and/or wherein the grinding elements are adapted to size screen pulverized solid dosage form such that particles above a threshold size are retained within the upper reservoir and/or pulverising zone(s) while smaller particles pass through the grinding elements into the lower reservoir zone of the sample preparation bag.

7-18. (canceled)

19. The apparatus of any one of the preceding claims further comprising a programmable controller for actuating movement of the jaw(s) and/or the pumping means.

20. (canceled)

21. The apparatus of claim 1 further comprising an upper pump assembly comprising pumping means comprising a member for contacting an outer surface of the upper reservoir zone of the sample preparation bag and thereby displacing extraction fluid contained therein to the pulverizing zone thereof.

22. The apparatus of claim 1 wherein the pumping means of the lower and/or upper pump assembly comprises means for compressing the flexible walls of the sample preparation bag.

23. The apparatus of claim 22 wherein the compressing means is: (a) a moveable plate or a roller; and/or (b) adapted to displace a predetermined and variable volume of extraction fluid; and/or (c) adapted to displace a predetermined and variable volume of extraction fluid at a rate of: 1-120, 2-60 or 10-30 displacements per minute.

24-27. (canceled)

28. The apparatus of claim 23 wherein the compressing means is a moveable plate or a roller and the pumping means comprises apparatus for agitating a liquid sample comprising: (a) a frame for holding the sample preparation bag, the sample preparation bag taking the form of an extraction pouch having walls defining a chamber in which a liquid sample comprising said solid dosage form and extraction fluid are confined, the pouch comprising a pair of opposed walls, at least one of which is flexible; (b) an agitator assembly comprising a roller adapted to roll over an outer surface of said flexible wall of the extraction pouch and to exert a rolling pressure thereon, whereby a portion of the pouch is compressed such that part of the liquid sample is displaced and forced to flow within the extraction pouch, under and/or around the roller, so agitating it within the sample chamber; and (c) a motor operably coupled to said agitator assembly and/or to said frame for reciprocating the roller relative to the extraction pouch, optionally wherein:
(A) the frame further comprises a support surface for supporting the wall opposed to said flexible wall of the extraction pouch; and/or
(B) the agitator assembly comprises one or more gapped roller(s); and/or
(C) the agitator assembly comprises one or more nip roller(s); and/or
(D) the agitator assembly comprises: (a) one or more fixed roller(s), for example one or more adjustable roller(s); and/or (b) one or more lifting roller(s); and/or
(E) said rolling pressure is provided by means selected from a weight, a coiled spring, a lever spring, gas spring, hydraulic strut, solenoid, servo-motor or stepper-motor; and/or
(F) the roller comprises a plurality of rollers spaced apart on a common spindle; and/or
(G) the roller comprises 2-8, 2-6 or 2-4 rollers spaced apart on a common spindle; and/or
(H) the roller comprises a plurality of rollers, wherein said plurality of rollers comprises a plurality of lifting rollers; and/or
(I) the agitator assembly comprises one or more profiled roller(s); and/or
(J) the extraction pouch is entirely flexible; and/or
(K) the extraction pouch has walls defining a liquid sample chamber of 1-1000 ml; 2-1000 ml; 5-1000 ml; 10-1000 ml; 25-500 ml; 20-1000 ml; 50-1000 ml; 50-750 ml; 50-500 ml; 1-100 ml; 1-5 ml; 1-10 ml or 1-25 ml; and/or
(L) the motor further comprises a programmable controller for actuating movement of the roller; and/or
(M) the roller reciprocates at a rate of: 1-120 strokes per minute, for example 2-60 strokes per minute.

29. The apparatus of claim 1 wherein: (a) l₁ is greater than: 2, 3, 4, 5 or 6 mm; and/or (b) f₁ is at least 30, 50, 100, 200, 250 or 300 strokes per minute; and/or f₂ is greater than 100, 300, 500, 1000, 2000, 2500 or 3000 strokes per minute or up to 10000 strokes per minute.

30-33. (canceled)

34. The apparatus of claim 1 wherein the upper pulverizer assembly of the jaw crusher further comprises a frame member to which the jaws are attached, wherein: (a) one of the jaws is fixed immovable to the frame and the other jaw is moveably fixed to the frame; or (b) both jaws are moveably fixed to the frame.

35. (canceled)

36. (canceled)

37. The apparatus of claim 34 wherein at least one moveable jaw is fixed to the frame by one or more eccentric shafts, wherein at least one moveable jaw is fixed to the frame by two eccentric shafts, wherein the two eccentric shafts comprise an upper shaft, rotation of which causes the opposed upper crushing surfaces to nip with said first stroke length l₁ and at said first frequency f₁ and/or wherein the two eccentric shafts comprise a lower shaft, rotation of which causes the opposed lower faces of the crusher plates to nip with said second stroke length l₂ at said second frequency f₂.

38-42. (canceled)

43. A jaw crusher for pulverizing a solid dosage form contained within a sample preparation bag as defined in claim 1, the crusher comprising:
(i) an upper pulverizer assembly comprising a pair of opposed jaws, said jaws being moveable relative to one another and each comprising opposed upper and lower crushing surfaces for contacting the outer surfaces of the pulverizing zone of the sample preparation bag and thereby exerting a crushing force on a solid dosage form contained therein via the crusher plates of the bag; and
(ii) a lower pump assembly comprising pumping means comprising a member for contacting an outer surface of the lower reservoir zone of the sample preparation bag and thereby displacing extraction fluid contained therein to the pulverizing zone thereof;
wherein the opposed upper crushing surfaces are adapted to nip with a first stroke length l₁ and at a first frequency f₁ and the opposed lower faces of the crusher plates are adapted to nip with a second stroke length l₂ at a second frequency f₂, and wherein l₁>l₂ and f₁<f₂.

44. (canceled)

45. A method for pulverising a solid dosage form comprising the steps of:
(a) placing one or more solid dosage form(s) within a sample preparation bag for containing said solid dosage form and an extraction fluid, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag; and
crushing the dosage form(s) by applying force to the crusher plates of the bag to pulverize the dosage form(s) by placing the bag containing the dosage form(s) in an upper pulverizer assembly as defined in claim 43.

46. (canceled)

47. A method for distributing a solid dosage form in an extraction fluid comprising the steps of:
(a) placing one or more solid dosage form(s) and an extraction fluid within a sample preparation bag, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag;
(b) recirculating extraction fluid containing the dosage form(s) between the upper and lower reservoir zones of the sample preparation bag by placing the bag containing the dosage form(s) and the extraction fluid between the jaws of a jaw crusher as defined in claim 19.

48. A method for distributing a solid dosage form in an extraction fluid comprising the steps of:
(a) placing one or more solid dosage form(s) and an extraction fluid within a sample preparation bag, the bag comprising flexible walls defining a sample preparation chamber having an opening through which solid dosage forms may be passed, the sample preparation chamber comprising: (i) an opening-proximal upper reservoir zone for receiving one or more solid dosage forms via the opening; (ii) an opening-distal lower reservoir zone for containing pulverized solid dosage form and/or extraction fluid; and (iii) a pulverizing zone between the upper and lower reservoir zones, wherein the pulverizing zone comprises opposed crusher plates fixed to a portion of each of the inner surfaces of two opposed walls of the bag;
crushing the dosage form(s) by applying force to the crusher plates of the bag to pulverize the dosage form(s)
distributing the pulverized dosage form(s) in the extraction fluid by placing the bag containing the dosage form(s) and the extraction fluid between the jaws of a jaw crusher as defined in claim 19.

49-57. (canceled)
